(19) United States
(12) Patent Application Publication
(10) Pub. No.: US 2018/0066745 A1
(43) Pub. Date: Mar. 8, 2018

(54) Apparatus for Passive Fluid Flow Control

(71) Applicant: GM GLOBAL TECHNOLOGY OPERATIONS LLC, DETROIT, MI (US)

(72) Inventors: Avinash Singh, Sterling Heights, MI (US); Mohammad A. Hotait, Rochester Hills, MI (US)

(21) Appl. No.: 15/257,990

(22) Filed: Sep. 7, 2016

(51) Int. Cl. F16H 57/04

(52) U.S. Cl. CPC F16H 57/0423; F03G 7/065; F16H 57/0457

(57) ABSTRACT

An apparatus for passive control of fluid flow between at least two volumes includes a first volume containing a fluid agitator and a second volume containing a fluid. A baffle disposed between the first and second volumes includes at least one opening that allows fluid flow to occur between the first and second volumes. A flow control device is passively manipulated in response to a condition change of either the first or second volumes to effect flow through the at least one opening in the baffle.

### FIELD

Apparatuses consistent with exemplary embodiments relate to apparatuses for passive fluid flow control. More particularly, apparatuses consistent with exemplary embodiments relate to apparatuses for passive fluid flow control between at least two volumes.

### BACKGROUND

The statements in this section merely provide background information related to the present disclosure and may or may not constitute prior art.

Propulsion systems in motor vehicles require lubrication and cooling using a hydraulic fluid or oil to continuously operate. More specifically, the engine and especially a transmission require lubricating and cooling fluids or oils to maintain their operation and extend their useful life.

A gear rotating in a transmission fluid or oil medium (an example is the pan or sump) will induce a fluid flow. This flow is arbitrary in nature and can collect on other rotating or non-rotating components. The thrown hydraulic fluid, being uncontrolled, causes splash from contact with other components, steady fluid, and/or different fluid flows. The fluid splashing back onto the rotating assembly can induce drag from the fluid impact. In addition, the fluid coming in contact with a rotating component can resist its motion causing additional drag and loss of power.

The consequence of too much fluid on rotation is more than mere friction which contributes to a loss of efficiency. An apparatus to control the flow of lubricating fluids could be operative towards mitigating power losses associated with excess fluid being churned by rotating transmission components.

### SUMMARY

One or more exemplary embodiments address the above issue by providing apparatuses for passive fluid flow control. More particularly, apparatuses consistent with exemplary embodiments relate to apparatuses for passive fluid flow control between at least two volumes.

According to an aspect of an exemplary embodiment, an apparatus for passive control of fluid flow between at least two volumes includes a first volume containing a fluid agitator and a second volume containing a fluid. Another aspects of the exemplary embodiment includes a baffle having at least one opening disposed between the first and second volumes operative to allow fluid flow between the first and second volumes. Still another aspects as according to the exemplary embodiment includes a flow control device operative to be passively manipulated in response to a condition change of either the first or second volumes to effect flow through the at least one opening.

In accordance with other aspects of the exemplary embodiment, the fluid agitator is a gear set. In accordance with further aspects of the exemplary embodiment, the fluid is a lubricant. Still in accordance with aspects of the exemplary embodiment, the flow control device includes a passive actuator.

Yet another aspect of the exemplary embodiment wherein the passive actuator is a thermal expansion material. And another aspect of the exemplary embodiment wherein the passive actuator is a memory alloy. Still another aspect of the exemplary embodiment wherein passive actuator is attached between an abutment at a first end and a lever arm at a second end. And another aspect wherein the passive actuator is in the form of a spring device.

According to another aspect of the exemplary embodiment wherein the condition change is a temperature increase or a temperature decrease. And another aspect wherein the lever arm is attached to the passive actuator at one end and attached to a fluid stop at an opposite end. Still further aspects of the exemplary embodiment wherein the passive actuator is operative to open or close the fluid stop when expanded.

Aspects according to a second exemplary embodiment provides an apparatus for passive control of fluid flow between a gear set within a first volume and a lubricant sump forming a second volume. The apparatus including a baffle having at least one opening disposed between the gear set and lubricant sump operative to allow fluid flow between the first and second volumes. A further aspect of the second exemplary embodiment includes a flow control device operative to be passively manipulated in response to a condition change of either the first or second volumes to effect flow through the at least one opening.

### BRIEF DESCRIPTION OF THE DRAWINGS

The present exemplary embodiments will be better understood from the description as set forth hereinafter, with reference to the accompanying drawings, in which:

FIG. 1 is an illustration of a transmission gear box where the flow control device allows a higher fluid flow through a baffle when the temperature is lower in accordance with an exemplary embodiment;

FIG. 1a is an illustration of an enlarged view of the flow control device of FIG. 1 in accordance with the first exemplary embodiment;

FIG. 2a is an illustration of an enlarged view of the flow control device allowing a higher fluid flow through the baffle when the temperature is lower in accordance with a first exemplary embodiment;

FIG. 2b is an illustration of an enlarged view of the flow control device not allowing a higher fluid flow through the baffle when the temperature is higher in accordance with the first exemplary embodiment;

FIG. 2c an illustration of an enlarged view of the flow control device not allowing a higher fluid flow through the baffle when the temperature is lower in accordance with a second exemplary embodiment; and

FIG. 2d is an illustration of an enlarged view of the flow control device not allowing a higher fluid flow through the baffle when the temperature is higher in accordance with the second exemplary embodiment.

### DETAILED DESCRIPTION OF THE INVENTION

The following description is merely exemplary in nature and is not intended to limit the present disclosure, application, or uses thereof.

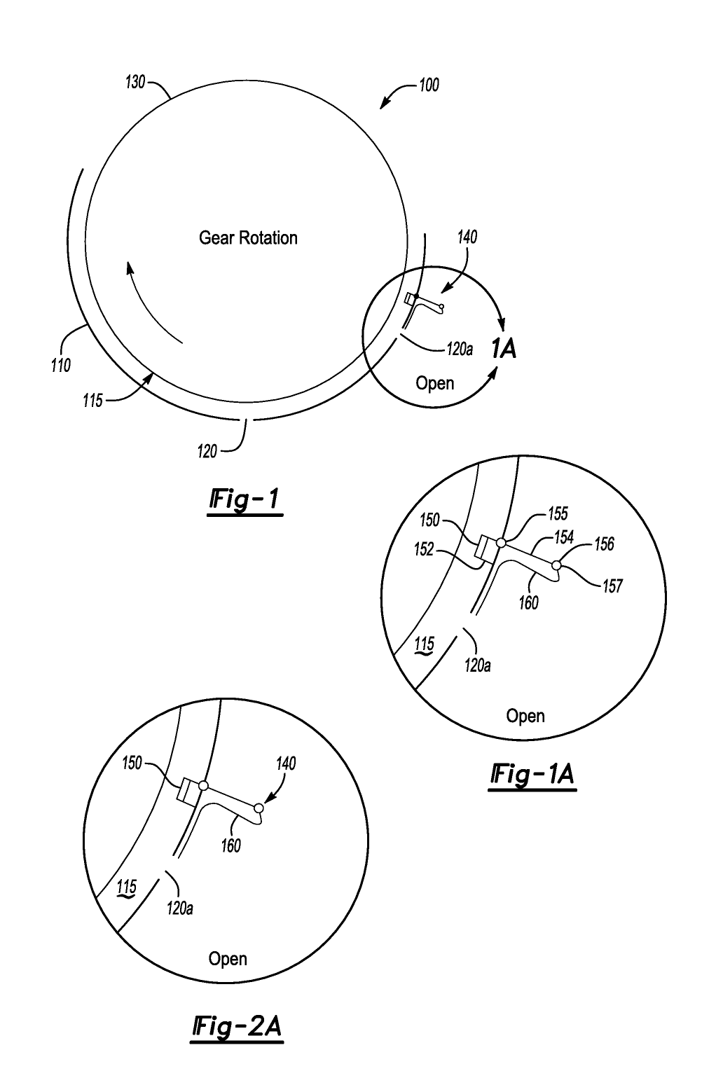

FIG. 1 provides an illustration of a transmission gear box 100 where the flow control device 140 allows a higher fluid flow when the temperature is lower in accordance with aspects of an exemplary embodiment. In the exemplary embodiment, the gear box 100 includes a baffle 110 having at least one opening 120 that allows for fluid flow between at least two volumes wherein a first volume 115 can receive fluid from, or deliver fluid to, a second volume (not shown). A second opening 120a also allows for fluid communication between the first volume 115 and the second volume. The first volume 115 includes at least one rotatable gear set 130 shrouded by the baffle 110.

It is appreciated that the rotating gear set 130 will generate heat in the gear box 100 such that a cooling/lubricating fluid is generally used to prevent overheating and reduce friction wear. The rotating gear set 130 acts as an agitator to the cooling/lubricating fluid within the gearbox 100 and too much fluid being agitated can cause power losses and reduced efficiency in the transmission. Regulating the amount of lubricating fluid into the gearbox 100 can effectively mitigate the losses associated with fluid agitation and churning.

A flow control device 140 is provided to regulate fluid flow through the at least one opening (120, 120a) disposed within the baffle 110. The flow control device 140 includes a passive actuator 150 which is operative to expand or contract in response to a condition change within the first volume 115 or the second volume. A condition change as according to aspects of the exemplary embodiment could be a change in temperature, volume, fluid viscosity, gear velocity or other condition change of the first or second volumes.

In accordance with aspects of the exemplary embodiment, the passive actuator is formed on a thermal expansion/contraction material or a memory alloy but other materials suitable for a particular application may be contemplated. According to the exemplary embodiment, the passive actuator 150 is attached between an abutment 152 at a first end and a lever arm 154 at a second end. Adjacent the second end of the passive actuator 150 is a first pivot point 155 of the lever arm 154.

At a second end 156 of the lever arm 154 is a second pivot point 157 to which a fluid stop 160 is attached to prevent fluid flow through the at least one opening (120, 120a) when it is closed. It is appreciated that the flow control device 140 as illustrated may be applicable to either of the at least one openings 120 or 120a without limiting the scope of the exemplary embodiment. It is appreciated that there may be multiple holes that are affected by a single flow control device 140 or multiple flow control devices, respectively, Also, the baffle 110 may only include holes such as 120a that are affected by flow control devices 140 and/or multiple holes 120 where fluid flow is allowed to flow between multiple volumes unimpeded. A flow control device 140 may be disposed to regulate fluid flow at either opening independently or simultaneously in accordance with aspects of the embodiment. Accordingly, in response to a condition change the passive actuator 150 will cause the lever arm 154 to manipulate the flow stop 160 such that fluid flow is either allowed or prevented through the at least one opening (120, 120a) disposed in the baffle 110. It is appreciated that the flow control device 140 is intended to prevent fluid from being drawn into, or pumped out of, the first volume 115 as according to the exemplary embodiment.

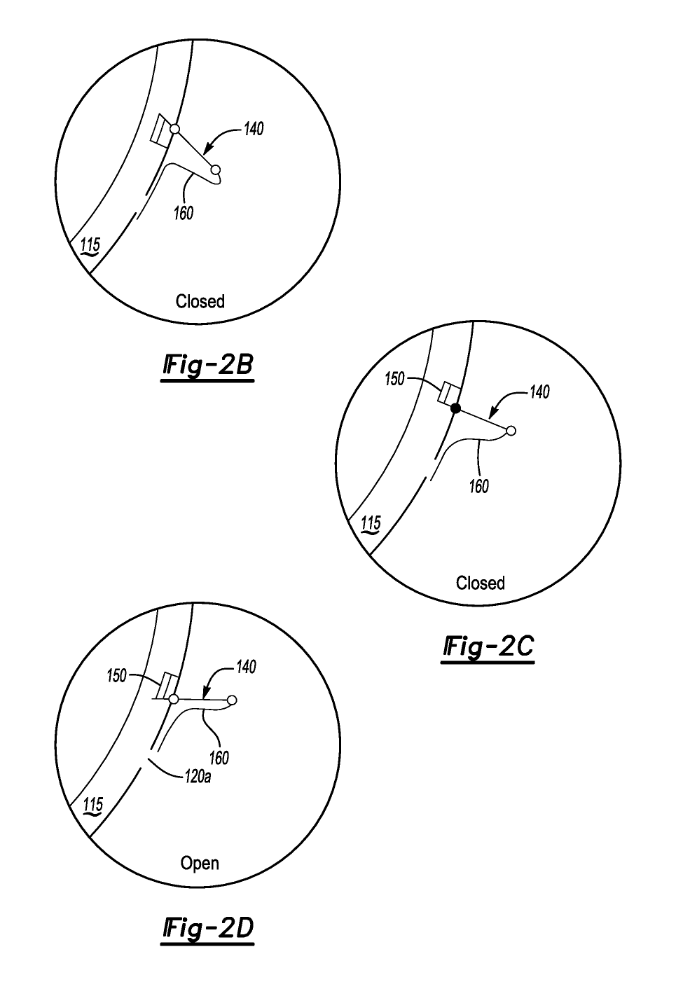

Referring now to FIG. 2a, an illustration of an enlarged view of the flow control device 140 allowing a higher fluid flow through the baffle when the temperature is lower in accordance with a first exemplary embodiment is provided. In this embodiment, the flow control device 140 includes a passive actuator 150 disposed in the first volume 115 is at a low temperature condition. As such, the physical state of the passive actuator 150 is unchanged from an original contracted state. In this condition, the fluid flow through opening 120a in the baffle 110 is allowed and, due to the churning environment cause by the rotating gear set 130, fluid is pumped into the first volume 115 from the second volume (or lubricant sump) as according to the exemplary embodiment.

Referring to FIG. 2b, an illustration of an enlarged view of the flow control device of FIG. 2a not allowing a higher fluid flow through the baffle 110 when the temperature is higher in accordance with the first exemplary embodiment is provided. In this case, the passive actuator 150 is expanded and the flow control device 140 is closed. Due to the condition change of an increase in temperature in the first volume 115, the passive actuator 150 expanded causing the lever arm 154 of the flow control device 140 to close the fluid stop 160 over the at least one opening 120a stopping fluid from being drawn into the first volume in accordance with the exemplary embodiment.

In FIG. 2c, an illustration of an enlarged view of the flow control device 140 not allowing a higher fluid flow through the baffle 110 when the temperature is lower in accordance with a second exemplary embodiment is provided. In this case, the flow control device 140 starts in a closed position and the passive actuator 150 is in a contracted state. The low temperature condition within the first volume 115 does not cause the passive actuator 150 to manipulate the flow control device 140. However, in FIG. 2d, the passive actuator 150 expands due to a temperature increase in the first volume 115. As such, the fluid stop 160 of the flow control device is manipulated to the open position allowing fluid to flow through the at least one opening 120a into the first volume 115 from the lubricant sump (not shown).

The description of the invention is merely exemplary in nature and variations that do not depart from the gist of the invention are intended to be within the scope of the invention. Such variations are not to be regarded as a departure from the spirit and scope of the invention.

What is claimed is:

1. An apparatus for passive control of fluid flow between at least two volumes comprising:
a first volume containing a fluid agitator and a second volume containing a fluid;
a baffle having at least one opening disposed between the first and second volumes operative to allow fluid flow between the first and second volumes; and
a flow control device operative to be passively manipulated in response to a condition change of either the first or second volumes to effect flow through the at least one opening.

2. The apparatus of claim 1 wherein the fluid agitator is a gear set.

3. The apparatus of claim 1 wherein the fluid is a lubricant.

4. The apparatus of claim 1 wherein the flow control device includes a passive actuator.

5. The apparatus of claim 4 wherein the passive actuator is a thermal expansion material.

6. The apparatus of claim 4 wherein the passive actuator is a memory alloy.

7. The apparatus of claim 4 wherein the passive actuator is attached between an abutment at a first end and a lever arm at a second end.

8. The apparatus of claim 1 wherein the passive actuator is in the form of a spring device.

9. The apparatus of claim 1 wherein the condition change is a temperature increase.

10. The apparatus of claim 1 wherein the condition change is a temperature decrease.

11. The apparatus of claim 7 wherein the lever arm is attached to the passive actuator at one end and attached to a fluid stop at an opposite end.

12. The apparatus of claim 11 wherein the passive actuator is operative to close the fluid stop when expanded.

13. The apparatus of claim 11 wherein the passive actuator is operative to open the fluid stop when expanded.

14. An apparatus for passive control of fluid flow between a gear set within a first volume and a lubricant sump forming a second volume comprising:
a baffle having at least one opening disposed between the gear set and the lubricant sump operative to allow fluid flow between the first and second volumes; and
a flow control device operative to be passively manipulated in response to a condition change of either the first or second volumes to effect flow through the at least one opening.

15. The apparatus of claim 14 wherein the flow control device includes a passive actuator.

16. The apparatus of claim 15 wherein the flow control device is formed of a thermal expansion material.

17. The apparatus of claim 15 wherein the flow control device is formed of a memory alloy.

18. The apparatus of claim 15 wherein the passive actuator is attached between an abutment at a first end and a lever arm at a second end.

19. The apparatus of claim 15 wherein the passive actuator is a spring device.

20. The apparatus of claim 18 wherein the lever arm is attached to the passive actuator at one end and attached to a fluid stop at an opposite end.

21. The apparatus of claim 15 wherein the flow control is operative to close the baffle when expanded.

22. The apparatus of claim 15 wherein the actuating device is operative to open the baffle when expanded.
